(19) United States
(12) Patent Application Publication
(10) Pub. No.: US 2010/0234481 A1
(43) Pub. Date: Sep. 16, 2010

(54) POROUS CERAMICS MANUFACTURING METHOD

(75) Inventors: Masaki SUGIMOTO, Takasaki (JP); Masahito YOSHIKAWA, Takasaki (JP); Akinori TAKEYAMA, Takasaki (JP); Ken'ichiro KITA, Takasaki (JP); Masaki NARISAWA, Sakai (JP); Hiroshi Mabuchi, Sakai (JP)

Correspondence Address: BRUNDIDGE & STANGER, P.C., 2318 MILL ROAD, SUITE 1020, ALEXANDRIA, VA, 22314, US

(73) Assignees: JAPAN ATOMIC ENERGY AGENCY, Ibaraki (JP); OSAKA PREFECTURE UNIVERSITY PUBLIC CORPORATION, Osaka (JP)

(21) Appl. No.: 12/721,782

(22) Filed: Mar. 11, 2010

(30) Foreign Application Priority Data
Mar. 13, 2009 (JP) 2009-060349
May 28, 2009 (JP) 2009-128693

(51) Int. Cl. B05D 3/06; C08J 9/00

(52) U.S. Cl. 521/154; 427/496

(57) ABSTRACT

A method of manufacturing porous ceramics, for example, thin film used for gas separation is disclosed. In this method, a silicon based mixture polymeric material which is the ceramics precursor is applied on a ceramics substrate, crosslinked by using ionizing radiation under oxygen free conditions; and pyrolyzed under an inert gas after that.

### BACKGROUND OF THE INVENTION

The present invention relates to a method of manufacturing porous ceramics used for a fiber or thin film, which has high heat resistance and corrosion resistance.

Ceramics exhibits high-strength and high-heat resistance as well as oxidation resistance, radiation resistance and biological co-existing stability, and is served as usable materials under extreme environmental conditions in which high polymer materials and metallic materials cannot be applied. In addition, porous materials can be applied to various fields of applications such as light-weight materials, dissipation materials for vibration energy, absorbing materials and separation membranes for gas and liquid, and porous ceramics materials are also under rigorous investigation.

For example, silicon carbide (SiC) thin film which is a ceramic porous film is expected as a film which has excellent durability because it is chemically stable even at a temperature above 600° C., and has a low reactivity with reducing gases such as steam or methane. SiC thin film is made by using a chemical vapor deposition (CVD) method or a precursor method from silicon based polymer materials. The CVD method is a method of making the raw material gas of SiC react at the high temperature, and depositing on a surface of the substrate of a metal or a ceramic. As for the SiC thin film obtained by this method, it is difficult to provide functions of the selective permeability of gases etc. because it is a high purity and high density, and the stoichiometric ratio is also near one. The precursor method comprises the steps of film-forming, crosslinking and pyrolyzing, in which silicon based polymer material such as polycarbosilane (PCS) is used as a starting material. The SiC thin film made by the precursor method is an amorphous material of low density compared with single crystal and has nano holes through which gas molecules can be passed selectively. (for example, see JP2005-60493A, JP2004-356816A, L. L. Lee et al. Ind. Eng. Chem. Res. 40 2001, p. 612-616, and T. Nagano et al. J. Ceram. Soc. Japan p. 114, 2006, and p. 533-538).

In the pyrolyzing step by which this silicon based polymer material is converted to SiC, cracked gases such as hydrogen or methane are generated, and its weight decreases to increase the density due to the shrinkage of the volume. This shrinkage does not cause problems in the viewpoint of the shape maintenance in a manufacturing process of SiC fiber where three-dimensional volume shrinkage is allowed. In the manufacturing method of SiC thin film in which covering the surface of the porous substrate where the volume change is not accompanied, therefore the difference in the shrinkage between the thin film and the substrate acts as a tensile stress, and causes the occurrence of defects such as cracks etc.

For example, if the uncrosslinked PCS is pyrolyzed in an inert gas, the uncrosslinked PCS melt over the melting temperature of PCS. In that case, the low molecular weight component of PCS in addition to H₂ and CH₄, etc. are evolved, and the mass decrease over 40% and the volume shrinkage of 60% or more are caused. On the other hand, generally in a manufacturing method of SiC fiber etc. The insolubilization process is performed so as not to melt even at the temperature more than the melting point by heating fibers in an oxidation atmosphere to introduce oxygen in PCS after spinning into the fibers, and crosslinking PCS molecular chains through oxygen. As a result, the mass decrease is decreased to about 20% by the low molecular weight component evolved by the pyrolyzing step decreasing. However, the volume shrinkage is only decreased to about 50% because this oxygen is evolved as H₂O and CO₂ that the molecular size is large in addition to H₂ and CH₄ in a first stage of the pyrolyzing step. Therefore, it is difficult in the manufacturing method of SiC thin film to control the occurrence of defects such as cracks etc.

This problem can be reduced by thinning the film thickness. However, the effects of irregularities on the surface of the substrate increase greatly. That is, the film becomes thin too much in a convex region of the surface of the substrate, and the defects such as pinholes etc. are caused by shrinkage. In addition, the film thickness increases locally in a concave region, and the cracks as described above are caused. Because these defects become a cause of the deterioration in the gas separation ratio, it is necessary to decrease the generation of the pinhole by using a smooth porous substrate, and reduce the remaining defects by repeating two or more times the process of the film-forming and the pyrolyzing. (For example, see JP2007-76950A and R. A. Wach et al. Mater. Sci. Eng., B, 140, 2007, p. 8189.).

### BRIEF SUMMARY OF THE INVENTION

As a result of the verification of a variety of factors of defect production at SiC thin film preparation in the prior art, it has been understood that the tensile stress is applied to a part of surface of the substrate where the film thickness becomes non-uniform due to the irregularities formed by the shrinkage according to the pyrolyzing-conversion of silicon based polymer materials to ceramics. This tensile stress causes the defects such as cracks, pinholes etc., which deteriorate the gas separation ratio.

When ceramic thin film is used, for example, as a gas separation membrane, the gas is separated by molecular sieve mechanism in which only gas molecules of a specific molecular size can pass through nano holes. Therefore, to obtain the high separation ratio, the number of defects such as pinholes, cracks, etc. which is far larger than the molecular size should be decreased to the limit. Moreover, the thinner the thickness of an ideal film where the above larger defects do not exist, the smaller the penetration resistance is. Accordingly, the gas separation membrane having higher gas permeability can be made with a thinner film.

However, it is difficult to remove the defects completely in the actual preparation conditions of SiC thin film. Therefore, it is necessary to decrease the number of the defects such as pinholes etc. by carrying out the process of the film-forming to the pyrolyzing two or more times. However, the gas permeability has decreased because of the increase of the film thickness according to this process.

It is, therefore, required to provide an improved method of manufacturing ceramic thin film, in which the occurrences of defects such as pinholes, cracks etc. which cause the gas separation ratio decrease is controlled effectively even if the thin film is formed on a coarse porous substrate surface.

Further, in the known manufacturing methods of porous ceramics, it may be difficult to manufacture holes having the diameter in the order of nanometer. Accordingly, it is also required to provide an improved manufacturing method which can control easily the diameter of holes.

A first object of the present invention is to provide a method of manufacturing ceramic thin film for gas separation in which volume shrinkage according to making to ceramics can be decreased, cracks are prevented being generated, and the generation of defects such as pinholes, etc. can be controlled.

A second object of the present invention is to provide a method for manufacturing porous ceramics with safer process and with lower cost by using a simplified apparatus.

When the ionizing radiation is irradiated to PCS in an inert gas like the present invention, some PCS molecular chains are cut, active radicals are generated, and they recombine directly with other molecular chains. As a result, the entire PCS is crosslinked into a mesh-like pattern. Therefore, neither H₂O nor CO₂ are fundamentally generated in pyrolyzing step of the present invention. In addition, because a CH₃ side-chain of a PCS molecular chain which is a main source of CH₄ is incorporated into the crosslinking, an amount of emission of CH₄ is decreased. Therefore, the volume shrinkage due to the pyrolyzing can be reduced by 20% or more compared with the oxidation crosslinking.

In order to achieve the first object, the inventors enable making improved SiC thin film by variously examining crosslinking conditions of silicon based polymer thin film, in which the volume shrinkage due to the pyrolyzing is decreased, and the occurrence of defects such as pinholes etc. is controlled by crosslinking with the ionizing irradiation in an inert gas atmosphere or in the absence of oxygen.

According to a first aspect of the present invention, a method of manufacturing ceramic thin film for gas separation comprises the steps of: applying a silicon based mixture polymeric material which is the ceramics precursor on a porous ceramics substrate; crosslinking it by using ionizing radiation under oxygen free conditions; and pyrolyzing it under an inert gas after that. Because the silicon based mixture polymeric material is crosslinked in a high density and uniformly, a methyl branch etc. are incorporated into the crosslinking structure in addition, and the generation of CH₄ etc. due to the pyrolyzing is controlled in the oxygen free crosslinking, the volume shrinkage due to the pyrolyzing is controlled. As a result, the generation of the pinholes can be decreased, and the number of times of the conventional process of the film-forming step to the pyrolyzing step is decreased greatly.

In order to achieve the second object, in the manufacturing method of porous ceramics according to the present invention, polymer blend is prepared by blending an excessive amount of polymer materials such as silicon oil with Si—O—Si bonds as a main chain compared to its limit of solubility with precursor polymer materials for SiC ceramics, and is used as the starting material, and then, the diameter of holes are controlled in responsive to their blending ratios, curing conditions and pyrolyzing conditions. The manufacturing method according to the present invention is characterized in forming the porous composition by blending multiple species of precursor polymer materials enabling to form ceramics.

By blending an excessive amount of one polymer material such as silicon oil including Si—O—Si bonds as a main chain compared to its limit of solubility with another ceramics precursor polymer material, that is, blending one polymer material at the blending ratios higher than the blending ratio for the complete compatibilization, polymer blend is so formed as to include polysiloxane-rich phase having an excessive amount of the polymer with Si—O—Si bonds as a main chain. This polymer blend is then cured by thermal oxidation reaction or radiation oxidation reaction caused by ionizing radiations, and further pyrolyzed at the temperature of 1000° C. or higher, and then converted to ceramics. The obtained ceramics is subsequently pyrolyzed at the temperature of 1300° C. or higher and finally converted to porous ceramics.

In this step, holes are formed as pyrolysis gas is produced from the polymer materials, with Si—O—Si bonds as a main chain, being located at the polysiloxane-rich phase. As the compatibility nature and the amount of produced pyrolysis gas are dependent of the distinctive molecular structure and molecular mass of the polymer materials with Si—O—Si bonds as a main chain, it is possible to control the number of polysiloxane-rich phase and their volumes. Note that the limit of solubility depends on the types of blended polymer materials, and, for example, as for the limit of solubility for blending polymethylhydrosiloxane (PMHS), its allowable blended fraction is 3% or higher, and as for the limit of solubility for blending plylmethylphenylsiloxane (PMPhS), its allowable blended fraction is 30% or higher.

The amount of produced pyrolysis gas from the polysiloxane-rich phase in the polymer materials changes in responsive to the amount of oxygen introduced into the polysiloxane-rich phase while being cured and the pyrolyzing temperature when converted into ceramics. The diameter of holes to be produced by the pyrolysis gas can be controlled by using intentionally this characteristic.

The number of defects such as pinholes, cracks etc. which remain in SiC thin film after pyrolyzing decreases in the manufacturing method according to the first aspect of the present invention because the shrinkage due to the pyrolyzing is decreased. Therefore, the SiC gas separation membrane of a high gas separation ratio and a high gas permeability can be made by an improved manufacturing method in which the number of repetitions of the process of the film-forming to the pyrolyzing is few compared with the conventional manufacturing method.

Because the shrinkage due to pyrolyzing can be decreased according to a manufacturing method of the present invention, even if the porous substrate etc. with large surface ruggedness is used, which it is difficult to apply as a substrate for a gas separation membrane in the conventional method, making the SiC gas separation membrane that the occurrence of defects such as pinholes, cracks etc. is controlled becomes possible. It is, therefore, not necessary to smooth the porous substrate with γ alumina that there is a problem in heat resistance and steam resistance etc. and possible to reduce the use temperature of the SiC thin film and the constraint of the use environment.

In addition, it is necessary to introduce pore-forming materials for gas permeability increase, oxygen for making to insolubility, and crosslinking agents in the prior art. However, these impurities result in reduction of heat resistance. Because these impurities are not introduced in a manufacturing method of the present invention, the SiC gas separation membrane having higher heat resistance and corrosion resistance can be made.

In the precursor-oriented method according to the second aspect of the present invention, it will be appreciated that the fiber structure and thin-film configurational shape which cannot be manufactured according to the powder compaction and the clay molding method can be manufactured, and specifically that the porous ceramics fiber and the ceramic thin film, both providing high heat-resistance and corrosion-resistance, can be manufactured. It is also appreciated that the porous ceramics with holes having the diameter of the order of nanometer which was difficult to be manufactured by the powder compaction and the clay molding method. It will be expected to manufacture porous and hollow ceramics fibers by combining with the manufacturing method of hollow ceramics fibers (see K. Kita, M. Narisawa, H. Mabuchi, M. Itoh, Key Eng. Mater., 352, 69 (2007)). In addition, it will be appreciated that any health hazard caused by fine power dust may not occur because of the manufacturing method without using fine powders.

### BRIEF DESCRIPTION OF THE SEVERAL VIEWS OF THE DRAWINGS

FIG. 1 is a schematic diagram showing one example of process in a method of manufacturing ceramic thin film for gas separation according to the present invention.

FIG. 2 is a graph showing the relationship among the number of times of the film-forming step, gas permeability, and gas separation ratio in the SiC thin film applied on a porous alumina substrate of which surface is smoothed with γ alumina by using the process of the present invention in which crosslinking is occurred by the ionizing radiation under oxygen free conditions.

FIG. 3 is a graph showing the relationship among the number of times of the film-forming step, gas permeability, and gas separation ratio in the SiC thin film applied on a porous alumina tube of which surface is smoothed with γ alumina by using the process of the present invention in which crosslinking is occurred by the ionizing radiation under oxygen free conditions.

FIG. 4 is a graph showing the relationship among the number of times of the film-forming step, gas permeability, and gas separation ratio in the SiC thin film applied on a porous alumina substrate of which surface is not smoothed by using the process of the present invention in which crosslinking is occurred by the ionizing radiation under oxygen free conditions.

FIG. 5 is a graph illustrating change in film thickness when PCS thin film made insolubility by an electron beam under oxygen free conditions, a PCS film made insolubility by thermal oxidation crosslinking, and uncrosslinked PCS thin film are pyrolyzed under an inert gas.

FIG. 6 is a schematic diagram of the manufacturing method of porous ceramics.

FIG. 7 is a schematic diagram of the spinning apparatus and the pyrolyzing apparatus used in the present invention.

FIG. 8 is an image of the porous ceramics fiber manufactured from PCS-PMPhS polymer blend, captured by the field emission-type scanning electron microscope.

FIG. 9 is an image of the porous ceramics fiber manufactured from PCS-PMPhS polymer blend, captured by the field emission-type scanning electron microscope.

### DETAILED DESCRIPTION OF THE PREFERRED EMBODIMENTS

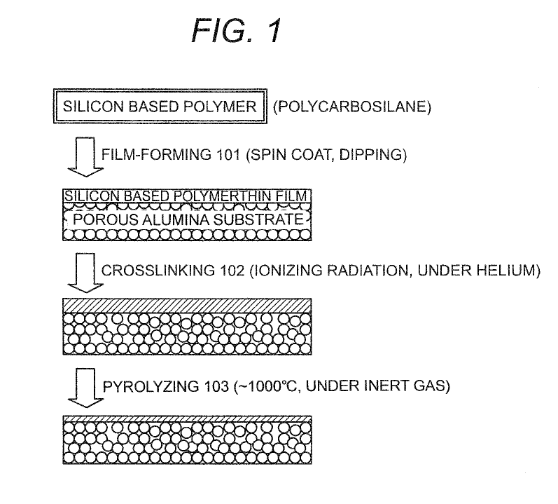

One example of the process of a method of manufacturing ceramic thin film for gas separation according to the present invention is shown in FIG. 1. Ceramics precursor polymers are dissolved at a fixed concentration to make a silicon based polymer solution. When silicon based polymer materials such as polycarbosilane (PCS), polyvinylsilane, or polytitanocabosilane are used as ceramics precursor polymer, organic solvents such as toluene, cyclohexane, THF, benzene, or xylene can be applied as a solvent. It is preferable to remove insoluble components and remaining dusts, etc. completely by using a filter etc. because particulate matters cause defects such as pinholes etc. when they remain in the solution.

A silicon based polymer solution is applied, for example, on a porous alumina substrate by a spin coat or dipping method (film-forming step 101). It is preferable that the film thickness of PCS spread with a single film-forming is 1 μm or less to control the crack formation due to the shrinkage at pyrolyzing when a silicon based polymer is PCS, for example.

Next, the electron beam irradiation which is the ionizing radiation under the oxygen-free environment of an inert gas or a vacuum, etc. is irradiated to silicon based polymer thin film, and crosslinking is formed (crosslinking step 102). It is necessary to irradiate the ionizing radiation up to the dose that a silicon based polymer becomes insoluble even at a temperature more than its melting point and also becomes insoluble to the solvent in the oxygen-free crosslinking by the ionizing radiation.

It is preferable to occur enough crosslinking with a higher dose of ionizing irradiation to increase the mass survival rate at the conversion to the ceramics by pyrolyzing, and to decrease the shrinkage to control the defect production. When silicon based polymer is PCS, for example. The dose by which the mass survival rate exceeds 80% is 8 MGy or more though the electron dose which becomes insoluble in solvents is about 5 MGy. Moreover, the mass survival rate decreases according to the mass decrease in the cracked gas generated by the irradiation if 15 MGy or more is irradiated to the silicon based polymer material crosslinked sufficiently. Therefore, the suitable dose for making the gas separation membrane is about 8-15 MGy.

Because the crosslinking of a silicon based polymer is not enough at an initial stage of the ionizing irradiation, there is a possibility for the temperature of the silicon based polymer exceeds the melting point due to the energy given by the ionizing radiation to enter a molten state. In this case, because the cracked gas generated by the irradiation becomes voids and they remain in thin film to cause defects, or the thin film flows and the inclination is caused in the film thickness. Accordingly, It is necessary to cool the thin film so as not to become a temperature more than the melting point of silicon based polymer by circulating helium having high thermal conductivity, or setting up silicon based polymer thin film on a stand which can be cooled with water, liquefied carbon dioxide etc.

Active radicals formed by the ionizing radiation remain in silicon based polymer thin film immediately after the irradiation, and these active radicals react promptly with oxygen when taking it out in to the atmosphere. The oxygen taken thus causes the decrease in gas permeability due to the rise of density or the decrease in heat resistance. it is, therefore, necessary to heat to 400° C. or more in an inert gas before taking it out into the atmosphere after irradiation, and to execute the annihilation disposal of the radicals. Further, it is preferable to process it continuously by using an irradiation and pyrolyzing apparatus which can heat up directly to a fixed temperature without taking it out into the atmosphere after irradiation.

Finally, the crosslinked silicon based polymer thin film is pyrolyzed in an inert gas, and the silicon based polymer thin film is converted into SiC thin film (pyrolyzing step 103). At this time, porous ceramics substrate expands and silicon based polymer thin film shrinks due to temperature rise. As a result, defects such as cracks etc. are caused due to the difference in shrinkage ratio. In the prior art, it is necessary to set the rate of temperature increase to 100° C./h or less in the temperature range of 500-1000° C. which shrinks most greatly, and control the defect production due to the difference in shrinkage factors. It is possible to improve the efficiency of the pyrolyzing step in the oxygen-free crosslinking according to the present invention which uses the ionizing radiation, because the thin film can be heated at the rate of temperature increase of 200° C./h or more even in the above temperature range by virtue of the decrease in the shrinkage.

The process of the film-forming to the pyrolyzing is repeated until the defects such as pinholes etc. disappears. As a result, it becomes possible to manufacture a ceramic gas separation membrane which can separate hydrogen etc. from other gases by using a molecular sieve mechanism.

Thinner film thickness is preferable to increase the gas permeability of SIC thin film obtained by pyrolyzing. However, it is required to repeat the process of the film-forming step to the pyrolyzing step because the number of defects such as pinholes etc. increases due to the ruggedness and dust on the surface of the substrate, and the gas separation ratio decreases. Therefore, it is necessary to form the film thickness of 100-200 nm, and repeat the process of the film-forming to the pyrolyzing four times or more in case that a conventional thermal oxidation crosslinking method is applied to PCS thin film. However, because the shrinkage is small because of the crosslinking formation under the oxygen-free environment, and the generation of pinholes is little in the present invention, the number of times of the process of the film-forming to the pyrolyzing can be little. As a result, the film thickness can be thinned, and the ceramic thin film with excellent gas permeability is obtained according to the present invention.

Moreover, because the shrinkage at the pyrolyzing step is decreased in the ionizing radiation oxygen-free crosslinking method according to the present invention, it becomes possible to use porous ceramics whose surface is irregular as a substrate. For example, a ceramic gas separation membrane which has functions of a molecular sieve mechanism can be manufactured by repeating four times the process of the film-forming to the pyrolyzing for the porous ceramics substrate whose surface layer is a alumina with the particle size of about 100 nm. Because it is not required to use γ alumina which has problems in heat resistance and steam resistance, etc., an excellent ceramic gas separation membrane in heat resistance and steam resistance, etc. can be made.

### Embodiment 1

A manufacturing method according to a first aspect of the present invention will be explained further with reference to an embodiment in which polycarbosilane (PCS) as a ceramics precursor polymer is applied on a porous alumina substrate. The following examples are intended to illustrate the invention and are not to be construed as being limitations thereon

A PCS solution was applied on a porous alumina substrate so as to form the film thickness of about 200 nm by adjusting the concentration of the PCS solution and the rotation speed of the spin coat. The substrate applied was put on a specimen support which has the water-cooled function. And thereafter, this is put into the electron beam irradiation container which can substitute an environment with a vacuum, and the electron beam of 2 MeV was irradiated to 12 MGy in the presence of helium flow. The dose rate of the electron beam was gradually increased like 0.4 kGy/s, 0.8 kGy/s, and 1.6 kGy/s, etc. The temperature rise was controlled by giving low dose rate irradiation because a heatproof temperature was low at an initial stage in which PCS thin film in the state of low crosslinking. Moreover, the dose rate has been increased at the stage where a heatproof temperature rises accompanying entering the state of high crosslinking.

It becomes possible to execute the irradiation processing efficiently by shortening the irradiation time by using this method. The sample was heated up to 400° C. under argon flow after irradiation, and the annihilation disposal of radicals was done. The sample was moved to a quartz furnace tube after cooling up to the room temperature, pyrolyzed up to 700° C. under argon flow, and then stood to cool up to the room temperature. The process of the film-forming to the pyrolyzing was executed a fixed number of times, and SiC thin film was manufactured. The process of the film-forming to the pyrolyzing was executed under the atmospheric pressure.

The gas separation examination of the SiC thin film was performed by using a “Pressure method with a pressure detector” in which the gas permeability is measured by keeping one separated (low-pressure side) in vacuum, introducing the examination gas into the other (high-pressure side), and measuring an increase in pressure in the low-pressure side. In this measurement, hydrogen or nitrogen of 1×10⁵ Pa (one atmospheric pressure) was used for the high-pressure side. The measured temperature was 200° C.

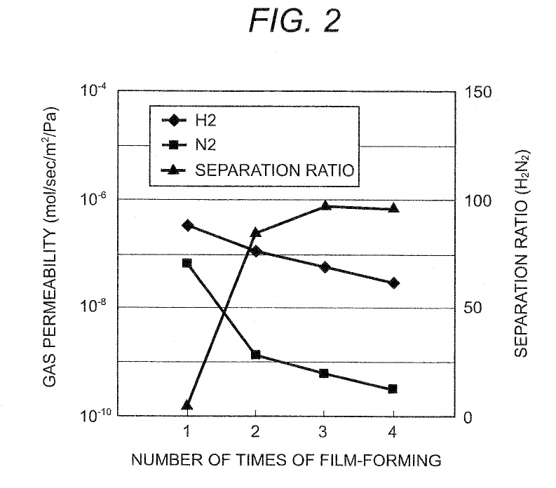

Details of the measurement result are shown in FIG. 2 to FIG. 4. FIG. 2 shows the result of performance test of the SiC thin film manufactured by the method according to the present invention. Concretely, FIG. 2 shows the relationship between the number of times of the film-forming (lamination layer) and the gas permeability and the relationship between the number of times of the film-forming and the gas separation ratio. In this example, polycarbosilane was applied on the α alumina porous substrate of mean diameter of 100 nm whose surface is smoothed with γ alumina of mean diameter of 10 nm by using a spin coat method. As is understood from FIG. 2, only twice film-forming steps make it possible to manufacture the SiC gas separation membrane whose separation ratio (H₂/N₂) is 100 or more and gas permeability is 10⁻⁷ (mol/sec/m²/Pa).

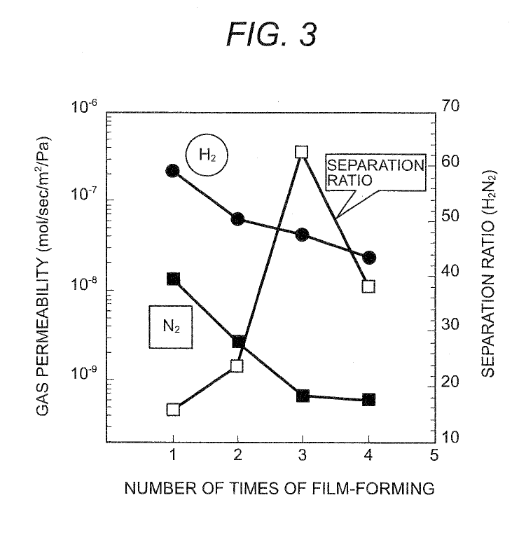

FIG. 3 is similar to FIG. 2. Concretely, FIG. 3 shows the relationship between the number of times of the film-forming (lamination layer) and the gas permeability and the relationship between the number of times of the film-forming and the gas separation ratio. In this example, polycarbosilane was applied on the cylindrical substrate where the surface of the α alumina porous tube of outer diameter φ of 6 mm is smoothed with γ alumina of mean diameter of 10 nm by using a dipping method. Also in case that the film-forming onto the cylindrical substrate necessary to manufacture an actual filter module etc. is executed by a dipping method, it was possible to manufacture an SiC gas separation membrane whose separation ratio (H₂/N₂) is 60 or more by 3 film-forming steps.

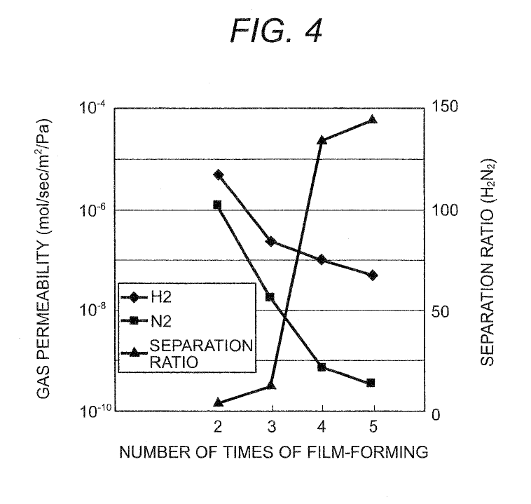

FIG. 4 is similar to FIG. 2 or FIG. 3. Concretely, FIG. 4 shows the measurement result of the gas permeability and the gas separation ratio of SiC thin film formed on the α alumina porous substrate of mean diameter of 100 nm which does not have the surface smoothed with the γ alumina by using substantially the same process as FIG. 2 or FIG. 3. Although it cannot measure the SiC thin film manufactured by a single process of the film-forming to the pyrolyzing because the gas over the measurement limit penetrates through one, the separation ratio was improved by repeating the process of the film-forming to the pyrolyzing. The SiC gas separation membrane whose separation ratio (H₂/N₂) is 130 or more and gas permeability is 10⁻⁷ (mol/sec/m²/Pa) was able to be manufactured by executing 4 processes of the film-forming to the pyrolyzing, which is equal to the repetition frequency when the SiC gas separation membrane is made for the γ layer smoothed substrate by using the conventional method.

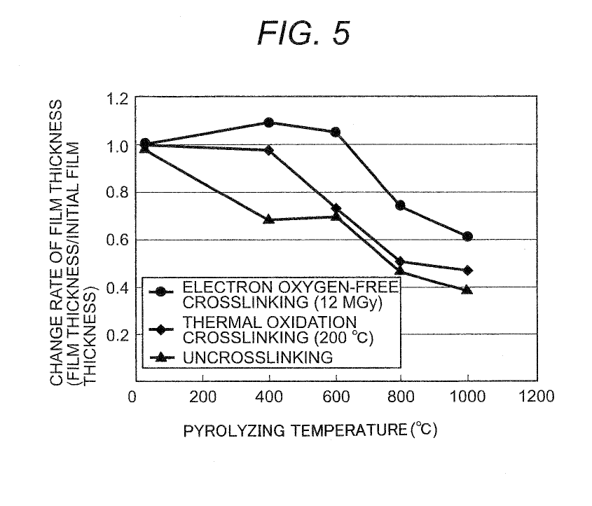

Finally, the difference in effect between the present invention and the prior art will be explained concretely with reference to FIG. 5. FIG. 5 shows the rate of change of the pyrolyzing temperature and the film thickness when the crosslinked PCS thin film and the uncrosslinked PCS thin film made respectively by the thermal oxidation crosslinking method in the prior art and the oxygen-free crosslinking method in the present invention are pyrolyzed under argon gas. When pyrolyzed, a lot of cracks are caused, and the film is divided into parts. Therefore, PCS thin film changes only in a direction of thickness, except when shrinking occurs in a direction of area. As a result, the rate of change of film thickness becomes equal to volume change.

In uncrosslinked PCS thin film, the volume shrinks 30% at 400° C., and 60% at 1000° C. Moreover, ceramic yield is also low, about 60%. Although the shrinkage up to 400° C. can be almost controlled for PCS thin film crosslinked by using the thermal oxidation method, the shrinkage begins at the temperature higher than 400° C., and reaches 50% at 800° C. On the other hand, in the oxygen-free crosslinking method according to the present invention, the volume shrinkage is improved by about 20% in the temperature range of 500 to 1000° C. compared with the conventional method. Accordingly, the present invention provides a significant advantage.

A manufacturing method according to a second aspect of the present invention will be explained next. In this method, it is possible to apply not only radiation oxidation curing method, but also thermal oxidation curing method instead.

In case of blending polymer materials, there exists a maximum blending ratio (limit of solubility) below which polymer materials can be blended uniformly, and phase separation occurs if the blended amount of one polymer material exceeds this limit. The present invention intentionally applies this characteristic, in which porous ceramics are manufactured by forming holes by carbon monoxide gas produced from the polysiloxane-rich phase of the polymer materials with Si—O—Si bonds as a main chain when pyrolyzing, by intentionally blending an excessive amount of the polymer material with Si—O—Si bonds as a main chain which tends to be gasified when pyrolyzing, compared to the limit of solubility.

According to the above mentioned characteristic, it is preferable that the blended amount of the polymer material with Si—O—Si bonds as a main chain is slightly larger than its limit of solubility. For example, in case of blending polymethylhydrosiloxane (hereinafter referred to as PMHS) as the polymer material with Si—O—Si bonds as a main chain with polycarbosilane as ceramic precursor, it is preferable that its blended amount is equal to or 30% larger than its limit of solubility.

In the following, the manufacturing method of porous ceramics according to the present invention and the porous materials manufactured by this method will be described in case that polycarbosilane is used as ceramic precursor polymer material, and that silicon oil is used as polymer material with Si—O—Si bonds as a main chain.

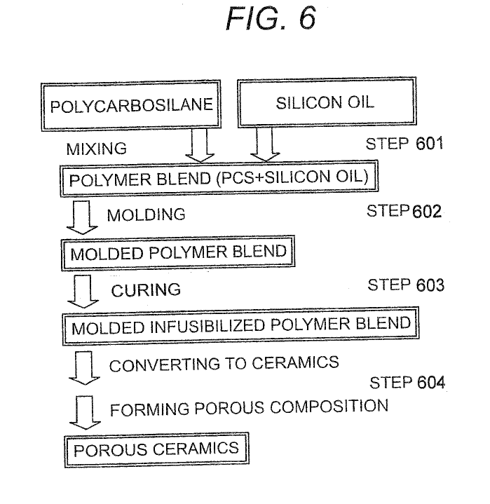

FIG. 6 shows one embodiment of the manufacturing method of porous ceramics according to the second aspect of the present invention.

### <Manufacturing Polymer Blend>

Polymer blend to be used as the material for porous ceramics is manufactured by blending silicon oil with ceramics precursor polymer material such as polycarbosilane (PC3) that enable to made ceramics (Step 601). In this manufacturing method, as the porous composition is formed by the pyrolysis gas produced at the polysiloxane-rich phase of the polymer blend, it is possible to control the hole diameter and the volumetric ratio of the holes by adjusting the blending ratio of the blended silicon oil. As it is required for establishing the porous composition to provide the polysiloxane-rich phase, it is necessary to make the blending ratio of the blended silicon oil larger than its weight ratio required for the complete compatibilization. In addition, it is desirable that the blending ratio of the blended silicon oil is 50 mass % or less in terms of volumetric ratio in comparison to the ceramic precursor polymer material used as the substrate material in order to maintain the shape of the porous composition.

In manufacturing the polymer blend, it is required to blend fully the ceramic precursor polymer material such as benzene, cyclohexane and toluene with silicon oil in the solvent in which those materials can be dissolved, and then remove the solvent completely by the vacuum freeze method. In case that the solvent cannot be removed completely only by the vacuum freeze method, it is preferable to remove further the solvent in the vacuum oven.

The manufactured polymer blend may be made shaped in the form of fiber by the conventional melt spinning step, or in the form of thin film by the spin coating or dipping step, and then the molded polymer blend is finished (Step 602).

### <Curing Step>

Curing step (Step 603) is such a step as applied in order to maintain the shape of the molded polymer blend in the form of fiber or film even when being heated at the pyrolyzing step at the temperature higher than its melting point. In this manufacturing method, thermal oxidation curing method can be applied in which the polymer blend is oxidized by heating the molded polymer blend in the air, and then the molecular chains in the polymer blend are crosslinked by the oxide; and radiation oxidation curing method can be applied in which the polymer blend is oxidized by the ionizing radiation, and then its molecular chains are crosslinked by the oxide used for oxidation.

In either curing method, as the oxide introduced in the curing step serves as the source element for the carbon monoxide forming the holes when pyrolyzing, it is required to define the amount of oxidation reactions to be at least by 1 mass % or more. In addition, in case that the polymer blend is shaped in the form of fiber and the like by the melt spinning step and the like, the required amount of oxide increases because it is required to increase the among of crosslink in the polymer blend in order to maintain the shape of fiber as it is, even in being heated when converting to ceramics by pyrolyzing.

Thermal oxidation curing method can be applied to the silicon oil including many reactive Si—H bonds. The amount of oxidation reactions can be controlled by adjusting the curing temperature and the holding time at the designated curing temperature. In case of holding a high temperature in a longer time, the amount of oxidation reactions reaches at most 15 mass %, leading to increasing the volumetric fraction of the hollow holes in the porous ceramics. In case of radiation oxidation curing method, the amount of oxidation reactions can be controlled by adjusting the dose of the ionizing radiation.

### <Pyrolyzing (Converting to Ceramics and Forming Porous Composition>

The cured specimen may be converted to ceramics by pyrolyzing in the inert gas atmosphere. It is required for this process to apply two-stage pyrolyzing (Step 604) in which the temperature may be increased up to 1000° C. and kept for 1 hour at the primary pyrolyzing, and then the temperature may be increased further to 1300 to 1500° C. at the secondary pyrolyzing.

In this step, the higher the temperature and the longer the holding time at the secondary pyrolyzing, the larger the amount of pyrolysis gas produced at the polysiloxane-rich phase. Therefore, it will be appreciated that the volumetric ratio of the holes in the porous ceramics can be increased. Note that it is preferable to make the pyrolyzing temperature being 1500° C. or lower in order to reduce the strength reduction due to pyrolytic reactions.

### Embodiment 2

Blending polymethylhydrosiloxane (hereinafter referred to as PMHS) as a kind of silicon oil including reactive Si—H bonds with polycarbosilane as one kind of ceramic precursor polymer at a blending ratio (mass % ratio) of PCS:PMHS=85:15, and dissolving them into benzene, the finished polymer blend is obtained by freeze and dry method. The finished polymer blend is then fused in the argon atmosphere at the temperature of 300° C., and then formed into the shape of fiber by the spinning apparatus (as illustrated at the upper part of FIG. 2).

As for the thermal oxidation and curing step, the finished fiber is heated up to the temperature of 185° C. with the air flow supplied at the rate of 1.5 L/min for the temperature rise time of 1.125 h or 20 times longer time of 22.5 h for increasing the amount of oxidation reactions, and the reached temperature is maintained for 1 h. The increased masses in the above oxidation steps are about 3 mass % and 7 mass %, respectively. After the curing step, the atmospheric gas inside the reactor is replaced by the argon, and then the temperature is increased up to 1000° C. at the temperature rise rate of 200° C./h, and furthermore the reached temperature is maintained for 1 h in order to apply the primary pyrolyzing. Then, the temperature is increased further up to 1500° C. and the reached temperature is maintained for 0.5 h in order to apply the secondary pyrolyzing.

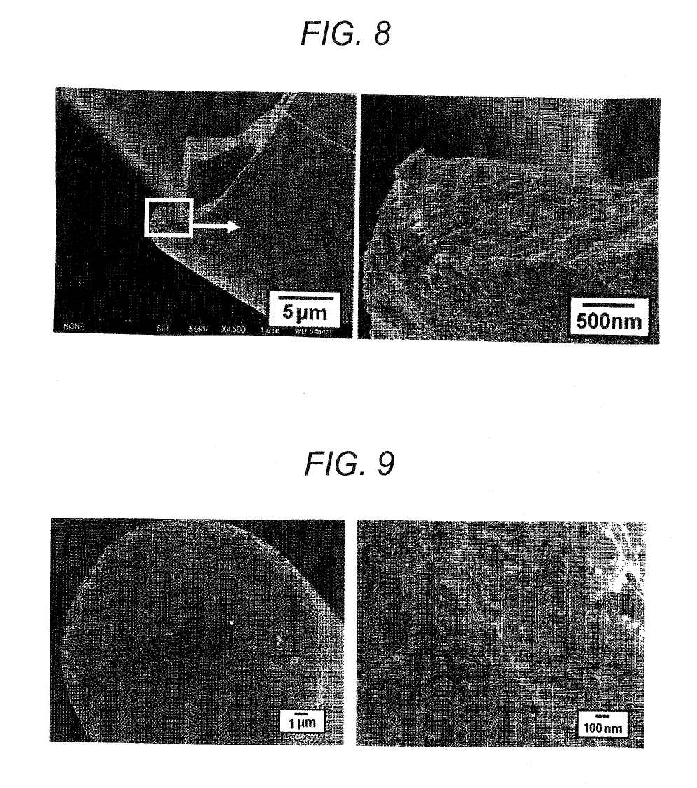

FIG. 8 illustrates the image of the obtained ceramics porous fiber, captured by the field emission-type scanning electron microscope. In FIG. 8, the image at the right side illustrates the magnified cross-sectional view of the ceramics porous fiber illustrated at the left side of FIG. 8.

The surface area (BET value) of the obtained porous ceramics fiber is 13.00 m²/g for the temperature rise time of 1.125 h in the curing step, and 36.82 m²/g for the temperature rise time of 22.5 h in the curing step, respectively.

### Embodiment 2

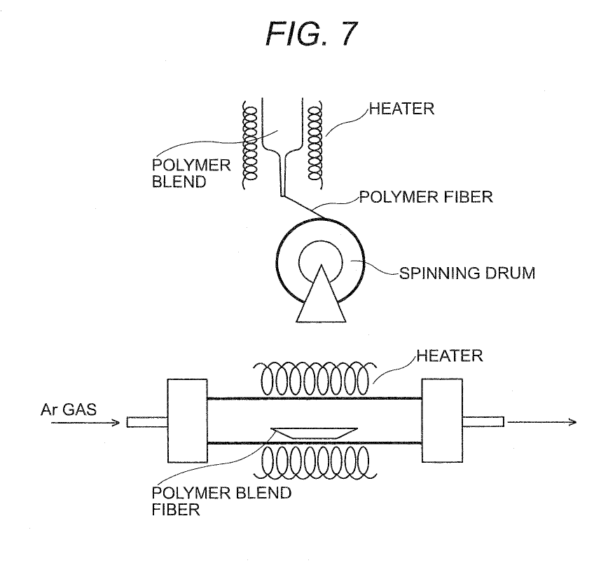

Blending polymethylhydrosiloxanes (hereinafter referred to as PMHS) as a kind of silicon oil including carbon bonds as a side chain with polycarbosilane as one kind of ceramic precursor polymer at a blending ratio (mass % ratio) of PCS:PMHS=70:30, and dissolving them into benzene, polymer blend is obtained by freeze and dry method. The finished polymer blend is then fused in the argon atmosphere at the temperature of 250° C., and then formed into the shape of fiber by the spinning apparatus (as illustrated at the upper part of FIG. 7). For the radiation oxidation and curing steps, the formed fiber is irradiated by γ-ray (with the dose rate of 6.45×10² C/kg·h) for 96 h. The increased masses in the oxidation step are about 7 mass %.

After the curing step, the formed fiber is provided inside the reactor, and then the atmospheric gas inside the reactor is replaced by the argon, and the temperature is increased up to 1000° C. at the temperature rise rate of 200° C./h, and furthermore the reached temperature is maintained for 1 h in order to apply the primary pyrolyzing. Then, the temperature is increased further up to 1400° C. and the reached temperature is maintained for 0.5 h in order to apply the secondary pyrolyzing. FIG. 9 illustrates the image of the obtained ceramics porous fiber, captured by the field emission-type scanning electron microscope. In FIG. 9, the image at the right side illustrates the magnified cross-sectional view of the ceramics porous fiber illustrated at the left side of FIG. 9.

1. A method of manufacturing ceramic thin film comprises:
applying a silicon based mixture polymeric material which is the ceramics precursor on a ceramics substrate;
crosslinking it by using ionizing radiation under oxygen free conditions; and
pyrolyzing it under an inert gas after that.

2. The manufacturing method according to claim 1, wherein said silicon based polymer material is polycarbosilane (PCS) or a polymer blend which other polymeric materials are mixed with PCS, and said ceramic thin film is silicon carbide (SiC) thin film.

3. The manufacturing method according to claim 1, wherein said ceramics substrate is a porous substrate whose surface is not smooth.

4. The manufacturing method according to claim 2, wherein said ionizing radiation is an electron beam irradiation.

5. The manufacturing method according to claim 4, wherein dose of said electron beam irradiation is 8-15 MGy, and said silicon based polymer material is maintained at a temperature below the melting point in an initial stage of the irradiation.

6. A method of manufacturing ceramic thin film comprises:
applying polycarbosilane (PCS) or a polymer blend which other polymeric materials are mixed with PCS, which is the ceramics precursor, on a porous ceramics substrate;
crosslinking it by using an electron beam irradiation under helium; and
pyrolyzing it under argon after that.

7. The manufacturing method according to claim 6, wherein said pyrolyzing step in the argon gas comprises:
heating it under argon until radicals annihilate;
cooling up to the room temperature once; and
pyrolyzing it under argon until converted to ceramics.

8. The manufacturing method according to claim 4, wherein dose of said electron beam irradiation is 8-15 MGy, and said silicon based polymer material is maintained at a temperature below the melting point by helium gas cooling in an initial stage of the irradiation.

9. A method of manufacturing porous ceramics comprising;
defining as a starting material, a polymer blend formed by blending an excessive amount of polymer material including Si—O—Si bonds as a main chain compared to limit of solubility with a precursor polymer material for SiC ceramics; and
applying an curing step and a pyrolyzing step to said polymer blend.

10. The manufacturing method according to claim 9, wherein
polysiloxane-rich phase of said polymer material blended including Si—O—Si bonds as a main chain is made gasified in said pyrolyzing step to form holes.

11. The manufacturing method according to claim 9, wherein
said curing step in a precursor method is performed by either heating, γ-ray irradiation or electron ray irradiation in order to cause phase separation of the polymer material including Si—O—Si bonds as a main chain in said polymer blend.

12. The manufacturing method according to claim 9, wherein
said polymer blend is pyrolyzed at a temperature of 1000° C. or lower in an inert gas atmosphere to form an amorphous structure, and then re-pyrolyzed at a temperature of 1300° C. or higher to form a porous composition.

13. The manufacturing method according to claim 9, wherein
a hole diameter and a volumetric ratio of said holes in a fiber is adjusted by adjusting a blending ratio of the polymer blend.

14. The manufacturing method according to claim 11, wherein
an occupation ratio of holes in a fiber is controlled by adjusting a condition for a temperature rise rate, a maximum temperature and a maximum temperature holding time during a thermal oxidation step and an curing step.

15. The manufacturing method according to claim 11, wherein
an occupation ratio of holes in a fiber is controlled by adjusting a condition for a dose rate and a total dose during a γ-ray curing step.

16. The manufacturing method according to claim 11, wherein
an occupation ratio of holes in a fiber is controlled by adjusting a condition for a dose rate and a total dose during an electron ray curing step, and adjusting a condition for an atmosphere during the curing step.

17. The manufacturing method according to claim 11, wherein
an occupation ratio of holes in a fiber is controlled by adjusting a temperature during the pyrolyzing step.

18. Porous ceramics manufactured by the manufacturing method in either of claims 9.
